(19) United States
(12) Patent Application Publication
(10) Pub. No.: US 2022/0406021 A1
(43) Pub. Date: Dec. 22, 2022

(54) Virtual Reality Experiences and Mechanics

(71) Applicant: Meta Platforms Technologies, LLC, Menlo Park, CA (US)

(72) Inventors: Michael James LEBEAU, Amsterdam (NL); Björn WANBO, London (GB); Gregg WYGONIK, Woodinville, WA (US); Saransh SOLANKI, Seatlle, WA (US); Sarang BORUDE, San Jose, CA (US); Jonathan KANTROWITZ, Brooklyn, NY (US); Alexandra Paige RUBIN, San Fransciso, CA (US); Wenjin GU, Markham (CA); Austen McRAE, Coronado, CA (US); Anis Ahmed SANKIGIRI KHADER, Cupertino, CA (US)

(73) Assignee: Meta Platforms Technologies, LLC, Menlo Park, CA (US)

(21) Appl. No.: 17/821,631

(22) Filed: Aug. 23, 2022

Related U.S. Application Data
(60) Provisional application No. 63/348,057, filed on Jun. 2, 2022.
(60) Provisional application No. 63/345,055, filed on May 24, 2022.
(60) Provisional application No. 63/288,746, filed on Dec. 13, 2021.

(51) Int. Cl. G06T 19/00; G06T 17/00; G06F 3/16; H04R 3/00

(52) U.S. Cl. CPC G06T 19/006; G06T 17/00; G06F 3/165; H04R 3/00

(57) ABSTRACT

Aspects of the present disclosure are directed to a mapping communication system that creates a 3D model of a real-world space and places a virtual camera in the 3D model. As the mapping communication system detects changes in the space, it can provide scan updates to keep the 3D model close to a live representation of the space. Further aspects of the present disclosure are directed to traveling a user to an artificial reality (XR) environment using an intent configured XR link. Yet further aspects of the present disclosure are directed to improving audio latency by performing audio processing off-headset for artificial reality (XR) experiences.

### CROSS REFERENCE TO RELATED APPLICATIONS

This application claims priority to U.S. Provisional Application Nos. 63/288,746 filed Dec. 13, 2021, titled “Pseudo-live Image Capture Using Virtual Cameras in Mapped Spaces,” with Attorney Docket Number 3589-0073DP01; 63/345,055 filed May 24, 2022, titled “Off-Headset Audio Processing for XR Experiences,” with Attorney Docket Number 3589-0147DP01; and 63/348,057 filed Jun. 2, 2022, titled “Intent Objects for Artificial Reality Links,” with Attorney Docket Number 3589-0136DP01. Each patent application listed above is incorporated herein by reference in their entireties.

### BACKGROUND

From work calls to virtual happy hours, webinars to online theater, people feel more connected when they can see other participants, bringing them closer to an in-person experience. Video conferencing has become a major way people connect, but such video calls remain a pale imitation of face-to-face interactions. Understanding body language and context can be difficult with only a two-dimensional representation of a sender is available, captured from wherever the sender is able to place a camera. Communication over video calling does not provide the ability for participants to fully understand spatial relationships, as the point of view is fixed to the sender's camera. Further, users tend to feel disconnected from other participants when the point of view of the sender's camera is different from where the sending user is looking (e.g., when the sending user is looking at a screen instead of a camera above that screen). In addition, the limitation of video calling on a flat panel display introduces an intrusive layer of technology that can distract from communication and diminishes the perception of in-person communication. Thus, users of existing remote communication systems typically have communications inferior to in-person interactions.

Artificial reality (XR) devices have grown in popularity with users, and this growth is predicted to accelerate. Users can share artificial reality environments to add a social element that enhances the experience. Mechanisms that support shared artificial reality experiences, such as links, often fail to account for the dynamic nature of artificial reality environments. For example, multiple instances of an artificial reality environment can be operating at any given time, and users can dynamically move throughout locations and/or environments of the artificial reality environments.

Artificial reality devices are becoming more prevalent. As they become more popular, the applications implemented on such devices are becoming more sophisticated. Augmented reality (AR) and Mixed Reality (MR) applications can provide interactive 3D experiences that combine the real world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. In MR, such interactions can be observed by the user through a head-mounted display (HMD), also referred to as a headset.

### SUMMARY

Aspects of the present disclosure are directed to a mapping communication system that creates a 3D model of a real-world space and places a virtual camera in the 3D model. As the mapping communication system detects changes in the space, it can provide scan updates to keep the 3D model close to a live representation of the space. Thus, output from the virtual camera placed in the 3D model can be used to create pseudo-live images, captured from any location in the space without a physical camera being present at that location. In some implementations, the mapping communication system can receive scans and generate 3D models for multiple senders, thus having the ability to generate pseudo-live images from multiple senders. In various implementations, a recipient can see a view, based on the pseudo-live images, into each of these multiple sender's spaces (e.g., in a grid layout) and/or into a single sender's spaces or a space of a selected one of the multiple senders (e.g., in window view).

Further aspects of the present disclosure are directed to traveling a user to an artificial reality (XR) environment using an intent configured XR link. XR environment users can create an XR link (e.g., a web uniform resource indicators (URL)) and share the link with one or more other users to support a shared XR experience. For example, in response to user input, a link manager can generate an XR link and one or more intent objects. In some implementations, the XR link can be associated with a generated intent object via an identifier for the XR link. Example information contained in an intent object includes travel type (e.g., travel to current location of a defined user, travel to current location of a defined group, travel to a defined XR environment location, travel to a current location of a defined XR environment entity, such as a moving vehicle, etc.), target entity (e.g., user, group, vehicle, other XR entity, etc.), permitted users (e.g., permitted user identifiers, permitted groups of users, etc.), other suitable link permissions (e.g., maximum number of user link activations, remaining number of user link activations, other suitable permission definitions, etc.), and any other suitable object intent information. After an XR link is shared, the link manager can receive user input from a candidate user (e.g., that received the shared link) that activates the XR link. In response, the link manager can retrieve the associated intent object(s) and compare the candidate user to the permissions stored in the intent object to determine whether the candidate user is permitted to active the link. When the link manager determines that the candidate user is permitted, the link manager can dynamically travel the candidate user to a target location (e.g., defined in the intent object, retrieved given a target user's/XR entity's current location, defined in the user input received from the candidate user, etc.)

Additional aspects of the present disclosure are directed to improving audio latency by performing audio processing off-headset for artificial reality (XR) experiences. Some implementations offload the audio processing to a mobile device, such as a cellular phone, through coordination between the cellular phone and the XR device, such as a headset. In an XR karaoke environment, for example, a user can select a song, effects, and other features on the XR device, which in turn can send audio controls to the user's cellular phone. The phone can receive user audio (e.g., singing) through its microphone, process the audio according to the received controls, and can output the audio through speakers on earphones or headphones or stream it to the XR device.

### BRIEF DESCRIPTION OF THE DRAWINGS

FIG. 1 is an example of a recipient's view into multiple sender's spaces in a grid layout, using a 3D model of those spaces, based on an artificial reality device's scan.

FIG. 2 is an example of a recipient's view of a single sender's space in a window layout, using a 3D model of the space, based on an artificial reality device's scan.

FIG. 3 is a flow diagram illustrating a process used in some implementations for creating a view, with pseudo-live images, into a space from a vantage where no physical camera exists.

FIG. 4 is a conceptual diagram for traveling a user to an artificial reality environment using an intent configured artificial reality link.

FIG. 5 is a conceptual flow diagram that illustrates conceptual relationships for implementing an artificial reality link using a rules-based workflow.

FIG. 6 is a sequence diagram illustrating a process used in some implementations for inviting a target a user to a shared artificial reality environment using an intent configured artificial reality link.

FIG. 7 is a flow diagram illustrating a process used in some implementations for traveling a user to an artificial reality environment using an intent configured artificial reality link.

FIG. 8 is a conceptual diagram illustrating a system of devices on which some implementations of the present technology can operate.

FIG. 9 is a block diagram illustrating an exemplary system including a mobile device on which some implementations of the present technology can operate.

FIG. 10 is a block diagram illustrating an exemplary system including a headset according to some implementations of the present technology.

FIG. 11 is a flow diagram illustrating a process for performing off-headset audio processing according to some implementations of the present technology.

FIGS. 12-15 are screenshots of views of an exemplary XR application that can be used in conjunction with some implementations of the present technology.

FIG. 16 is a block diagram illustrating an overview of devices on which some implementations of the present technology can operate.

FIG. 17 is a block diagram illustrating an overview of an environment in which some implementations of the present technology can operate.

### DESCRIPTION

Aspects of the present disclosure are directed to a mapping communication system that uses scans from an artificial reality device to map a real-world space. The mapping communication system can use these scans to create a 3D model of the space. The mapping communication system can place a virtual camera in the 3D model, which can create pseudo-live images, captured from any location in the space without a physical camera being present at that location. The term “pseudo-live,” as used herein, refers to how a model or image is updated as changes in the space that the image or model represents are made (either periodically or as changes are detected). Such pseudo-live images into the spaces of one or more sending users can be provided to a recipient, e.g., as a grid of views into multiple sender's spaces or as a larger window into a single sender's space. As the artificial reality device at the sender's location detects changes in the space, it can provide scan updates to keep the 3D model close to a live representation of that space, keeping it pseudo-live.

An artificial reality device can scan a real-world space using a depth camera and/or traditional cameras. In some implementations, the scan can be performed with another device, such as a mobile phone, equipped with appropriate cameras. Images from a depth camera can be associated with depth data (e.g., each pixel can have a depth measurement). Using data gathered by the capturing device indicating the device's position and/or movement within the space, the depth data can be transformed into points in 3D model (e.g., the depth data can be mapped into a coordinate system where points from depth data from different images, which may have been captured from different locations, are positioned relative to a consistent origin point across the images). Images from a traditional camera can be first converted into depth images, by applying a machine learning model trained to estimate depth data for traditional images before these created depth images are converted into 3D model. In some implementations, each of multiple senders can provide scan data of their space to a recipient or a central server, with the mapping communication system, that can use the scan data to generate the 3D model of the sender's space.

In some implementations, a scan of a space and a scan of the sending user can be captured separately, with the location of the sending user being mapped into the 3D model. Such scans of the sending user may continuously track positional data for the sending user (e.g., with a kinematic model), allowing the representation of the sending user to be updated more frequently than inanimate objects in the space.

Once a 3D model of a sender's space is created, the mapping communication system can add a virtual camera anywhere in the model, without a physical camera being present at a corresponding location in the real world. In some implementations, the sending user or the recipient user can manually select this location. In other implementations, the mapping communication system can automatically select the location, e.g., so the virtual camera is automatically pointed at the face of a sending user or at a workspace of the sending user.

The mapping communication system can use the pseudo-live images captured by the virtual camera into the 3D model of each sending user's space to create a view, for a recipient, into one or more sending users' spaces. In various implementations, a recipient can see a view, based on the pseudo-live images, into each of these multiple sender's spaces (e.g., in a grid layout) and/or into a single sender's spaces or a space of a selected one of the multiple senders (e.g., in window view).

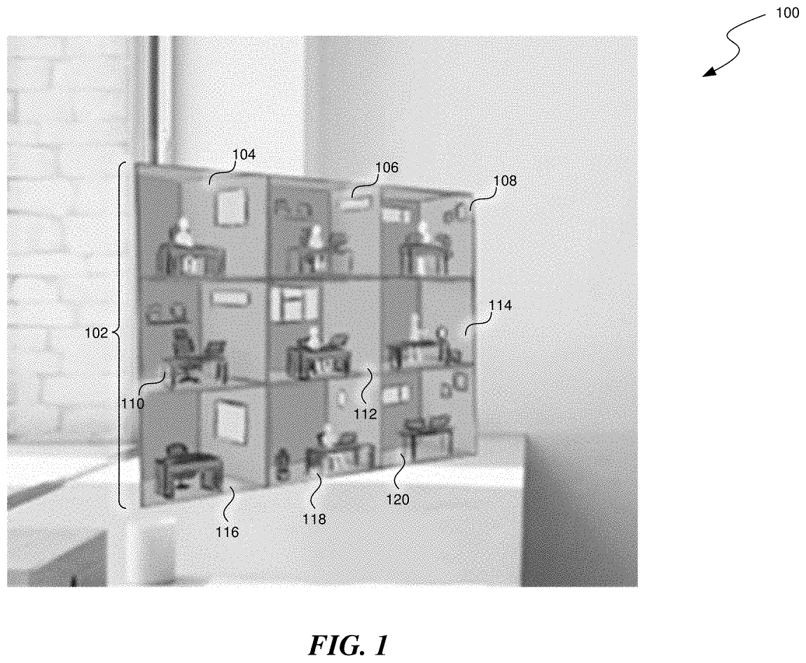

FIG. 1 is an example 100 of a recipient's view into multiple sender's spaces in a grid layout, using a 3D model of those spaces, based on an artificial reality device's scan. In example 100, a 3D object 102 is being presented in a recipient user's artificial reality environment, where the recipient user has placed the 3D object 102 on her desk. The 3D object 102 includes views 104-120, each looking into one of multiple sending users' spaces. In example 100, each sending user has provided a scan of that user's real-world space which was used to create a 3D model and a virtual camera is positioned looking into that 3D model to form one of the views 104-120.

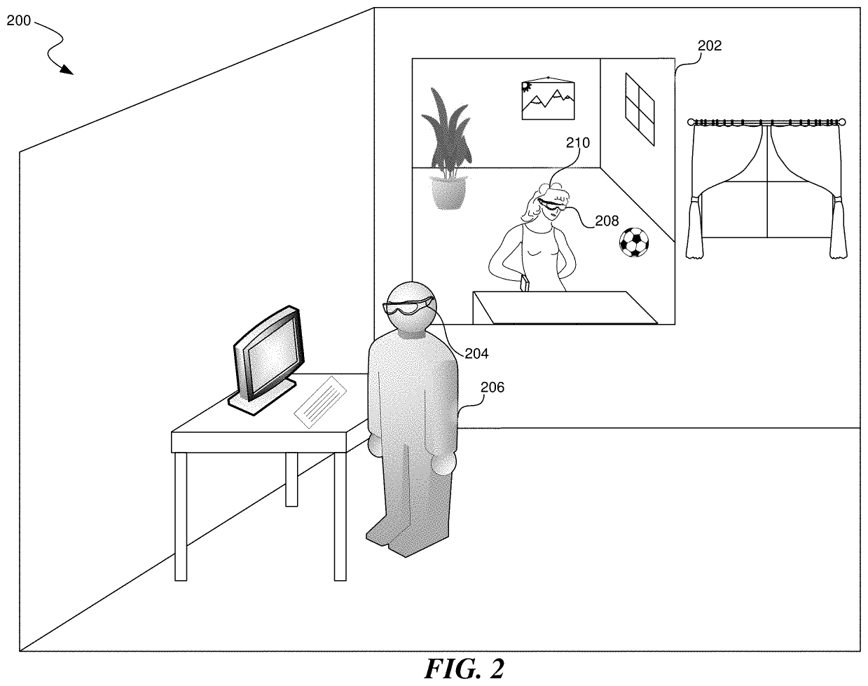

FIG. 2 is an example 200 of a recipient's view of a single sender's space in a window layout, using a 3D model of the space, based on an artificial reality device's scan. In example 200, a sending user 210 has scanned her physical space with her artificial reality device 208 and the mapping communication system has created a 3D model based on those scans. A virtual camera is positioned in the 3D model, which is used to capture images of the model from a vantage point where no physical camera exists. These images are used to create a window 202 into the sending user 210's space. This window 202 is provided to artificial reality device 204, which displays it as a world-locked virtual object, allowing user 206 to see it on his wall.

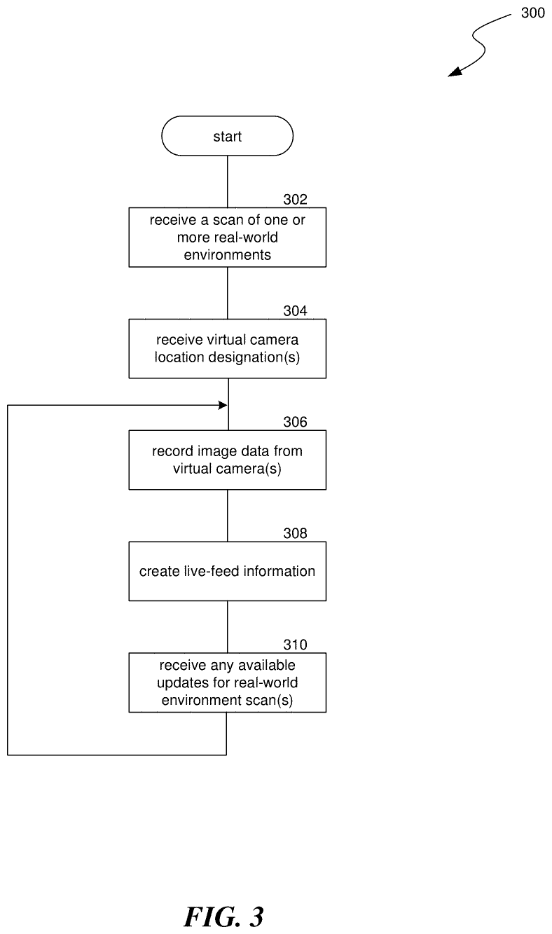

FIG. 3 is a flow diagram illustrating a process 300 used in some implementations for creating a view, with pseudo-live images, into a space from a vantage where no physical camera exists. In some implementations, process 300 can be initiated in response to executing an environment sharing application and can be performed on a server (e.g., that receives scans from one or more senders and generates views for one or more recipients) or on a recipient device that receives the scans from the one or more senders and generates the views.

At block 302, process 300 can receive a scan of one or more real-world environments. The scan can be based on depth images or traditional flat images, which can be converted to depth images by applying a machine learning model trained to estimate depth data for flat images. Process 300 can then use the depth images to create a 3D model (e.g., point cloud, mesh, etc.) of each of the real-world environments. This can include determining camera positions/orientations corresponding to each depth image (which can be tracked by the device capturing them or extrapolated from features in the images) and, based on this position/orientation data, map the depth data to specific points in a common 3D space (e.g., as offsets from an origin). In some implementations, a representation of the sending user can be included in the 3D model. In other cases, a representation of the sending user can be captured separately. For example, an artificial reality device worn by the sending user can capture a position of the sending user in the space and a kinematic model defining a pose of the sending user. In some cases, this pose can include facial features, such as expressions and mouth movement while talking. An avatar of the user can be included in the 3D model, which can be positioned and posed according to the captured position and pose data. This allows the user's position and pose to be updated separately from inanimate objects in the space, so the images of the user can be kept pseudo-live without having to rescan the entire space.

At block 304, process 300 can receive a virtual camera location designation for each of the 3D models. This location can be selected regardless of whether a real-world camera exists at that location. In some implementations, the sending user or the recipient user can manually select this location. In other implementations, process 300 can automatically select the location, e.g., so the virtual camera is automatically pointed at the face of a sending user or at a workspace of the sending user.

At block 306, process 300 can record image data from a virtual camera placed in the 3D model, of each of the one or more real-world environments, at the corresponding designated virtual camera location. This captures pseudo-live images of the 3D model, which corresponds to the space of the sending user at the time of the last scan and/or avatar position update.

At block 308, process 300 can create live-feed information for each of the one or more real-world environments as output to one or more recipients. In some implementations, the live-feed information can be configured as a window into the space of a sending user, which e.g., can be sized and positioned by the recipient user in her artificial reality environment, an example of which is shown in FIG. 2. In other implementations, the live-feed information can be configured as a grid of views into the space each of multiple sending users, an example of which is shown in FIG. 1. Various other output configurations or a combination of these output configurations are possible. For example, a grid of sending users' spaces can be shown and when one of the spaces is selected, it can be provided as a single larger window view.

At block 310, process 300 can receive any available updates for the scans of the one or more real-world environments. In some cases, this can include new scans of the space, updates to just the avatar position/pose data, or change data for the space. By providing only change data, the model of the 3D space can be kept up to date without having to reform the entire model each time there is a change. In various implementations, the updates can be provided periodically (e.g., every 10, 50, 100, or 500 milliseconds) or when a detected change occurs. As discussed above, in some cases, updates for the space and the updates for the avatar of the sending user can be provided separately.

Following block 310, while the environment sharing application is still executing, process 300 can return to 306, iterating through block 306-310 to update the 3D model and provide new pseudo-live views into sender's spaces.

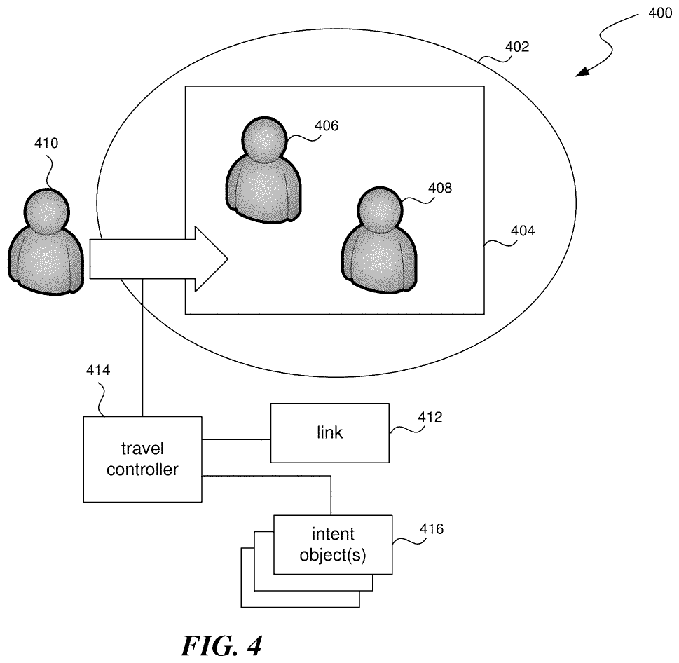

FIG. 4 is a conceptual diagram for traveling a user to an XR environment using an intent configured XR link. System 400 includes XR environment 402, location 404, users 406, 408, and 410, XR link 412, travel controller 414, and intent object(s) 416. The XR environment 402 can be any suitable XR environment that supports a shared XR experience for users 406, 408, and/or 410. In some implementations, XR environment 402 can be one of several running instances of an XR environment. Location 404 can be a static location within XR environment 402 or a dynamic location, such as a dynamically moving entity (e.g., car, ship, other suitable vehicle, other suitable XR entity that can contain users, etc.) When present in XR environment 402, users 406, 408, and/or 410 can be represented as avatars or using any other suitable user representation.

XR link 412 can be generated by travel controller 414 according to input from a user (e.g., one of users 406 or 408). For example, one or more generated intent object(s) 412 can be associated with XR link 412. Intent object(s) 412 can define intent parameters for implementing an XR link, such as A) travel type (e.g., travel to current location of a defined user, travel to current location of a defined group, travel to a defined XR environment location, travel to a current location of a defined XR environment entity, such as a moving vehicle, etc.), B) target entity (e.g., user, group, vehicle, other XR entity, etc.), C) permitted users (e.g., permitted user identifiers, permitted groups of users, etc.), D) other suitable link permissions (e.g., maximum number of user link activations, remaining number of user link activations, other suitable permission definitions, etc.), E) any other suitable object intent information, or F) any combination thereof.

XR link 412 can be shared with user 410, and user 410 can select/activate the shared link. In some implementations, user input from user 410 can also be received with the link selection/activation (e.g., permissions to enter XR environment 402, user device permissions, social graph permissions, etc.) In response to receiving the link activation, travel controller 414 can retrieve one or more matching intent object(s) 416. For example, an identifier for XR link 412 can match one of more of intent object(s) 416 associated with the XR link, and the matching intent object(s) can be retrieved.

Travel controller 414 can then compare user 410 to permissions defined by the matching intent object(s) 416. For example, the permission can define a set of user identifiers permitted to activate XR link 412, one or more user groups permitted to active XR link 412, a maximum number of users (or a remaining number of users) permitted to active XR link 412, a minimum rating for a user (e.g., peer rating), social graph parameters relative to a target user or target group of users (e.g., first connection to target(s), second connection to target(s), etc.), other suitable permissions, or any combination thereof. When user 410 meets the permissions defined by the matching intent object(s) 416 (e.g., the user identifier for user 410 matches the permissions, etc.), travel controller 414 can travel user 410 according to the travel defined in matching intent object(s) 416 and/or input from user 410.

For example, an intent object can store a target entity and a travel type that configures implementation of the XR link. Example travel types include join target user, join target group of users, join at target location, and other suitable travel types. The target entity defined within an intent object can include a target user, target user group, target location, or other suitable target entity (e.g., target moving vehicle, target dynamic location, etc.). In some implementations, travel controller 414 can dynamically travel user 410 to the target entity defined in an intent object, even if that entity moves, by: a) traveling the user to a current location of a target user; b) traveling the user to a current location of a target user group (or a predetermined location for the target user group, such as a private user group space); c) traveling the user to a target location or dynamically moving location (e.g., moving vehicle); d) or any combination thereof.

In some implementations, a target user, user group, vehicle, or dynamic location can be located within an artificial reality environment such that user 410 can by dynamically transported to the entity's current location. Travel controller 414 can perform a lookup (e.g., call to an XR environment tracking service) to locate an instance of an XR environment in which a target entity is present and/or a specific location within the instance. The tracking service can track the locations of users and other suitable XR environment entities using a registry, reporting logs, or any other suitable tracking technique.

In some implementations, XR link 412 and one or more corresponding intent object(s) 416 can be generated by one of users 406 or 408 and shared with user 410. For example, user 410 can join user 406 or user 408 in XR environment 402 using XR link 412 because XR link 412 (and its corresponding intent object) contain rules that define how a user is dynamically traveled via XR link 412. Users 406 and/or 408 can also travel through different XR environments and/or instances of XR environment 402. Implementations of XR link 412 can be dynamic, as user 410 can join users 406 or 408 at their current location via the link, regardless of which XR environment/instance the users are present within. In some implementations, XR link 412 can be a cross-platform invitation. For example, XR link 412 can be displayed to a candidate user outside of an XR environment, and selection/activation of XR link 412 can enter the candidate user into the XR environment via the link creator's intent (stored by the intent object 416 that backs XR link 412).

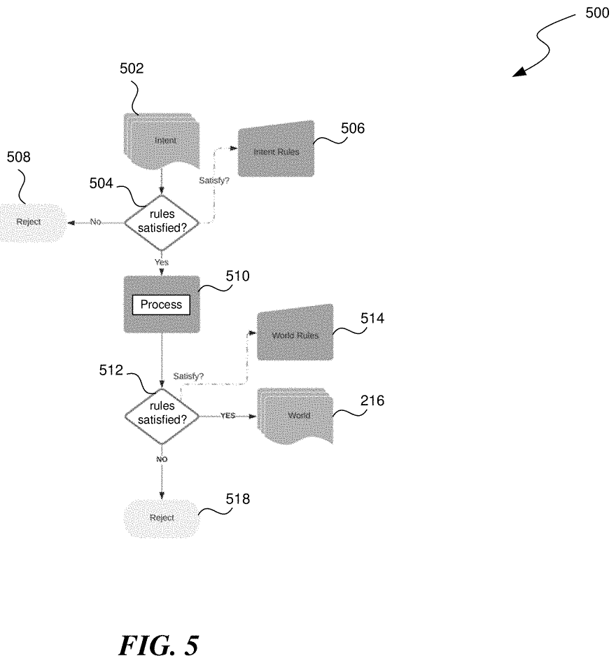

In addition, XR environment 402 may also include one or more rules that define which users can join the environment. FIG. 5 is a conceptual flow diagram that illustrates conceptual relationships for implementing an artificial reality link using a rules-based workflow. Conceptual flow 500 illustrates how traveling a user within an XR environment (e.g., world 516) using an XR link can be based on the traveling user, the intent of the XR link creator, and the rules of the XR environment.

Received intent input 502 can be an invited user selecting an XR link URL. In some implementations, intent input 502 can also include other user input, such as a user identifier for the invited user, client device permissions, social graph permissions, or other suitable input. After intent input 502 is received, an intent object that defines intent rules 506 can be retrieved.

Example intent rules 506 include a set of permitted user identifiers, a maximum number of permitted users, a number of open slots for invited users, permitted user groups, a minimum user rating, social graph parameters (e.g., social link conditions relative to target user(s)/the invitation creator(s)), or any combination thereof. At block 504, conceptual flow 500 can determine whether intent input 502 (and other corresponding invited user information) satisfies intent rules 506. For example, the invited user identifier, the invited user's social graph, the invited user's device parameters, and other suitable information/user input that corresponds to intent input 502 can be compared to the intent rules 506. When intent input 502 and the corresponding information satisfies intent rules 506 (e.g., the invited user identifier is permitted by intent rules 506, open spots remain for invited users, the invited user identifier has a user rating that satisfies intent rules 506, the social graph for the user identifier meets social graph parameters defined by intent rules 506, etc.), conceptual flow 500 can progress to block 510. When intent input 502 does not satisfy intent rules 506, conceptual flow 500 can progress to block 508, where the XR link activation for the invited user can be rejected.

At block 510, conceptual flow 500 can process the result from block 504. For example, conceptual flow 500 can resolve that intent input 502 and the corresponding information satisfies intent rules 506 and retrieve world rules 514. At block 512, conceptual flow 500 can determine whether intent input 502 and the corresponding information satisfies world rules 514. Example world rules 514 include user device criteria (e.g., AR environment compatible device, application compatible device, etc.), user subscription criteria, threshold number of active users, device permissions, and other suitable rules that a world may define for allowing a user to enter.

In some implementations, intent input 502 and other corresponding information (e.g., the invited user identifier, the invited user's social graph, the invited user's device parameters, and other suitable information/user input that corresponds to intent input 502) can be compared to world rules 514. When intent input 502 and the corresponding information satisfies world rules 514 (e.g., the invited user identifier has a subscription for world 516, open spots remain within world 516, the user's device parameters meet world rules 514, etc.), conceptual flow 500 can dynamically travel the invited user to world 516 (e.g., an instance of world 516 that matches intent input 502 or information retrieved according to intent 502). When intent input 502 does not satisfy intent rules 506, conceptual flow 500 can progress to block 518, where the XR link activation for the invited user can be rejected.

Implementations decouple matchmaking (e.g., matching an invited user to a target XR environment entity/location) from the invitation (e.g., XR link). When an initiator creates an invitation (e.g., XR link) to send to others, the invitation can be associated with an intent object that includes definitions that represent the intent of the initiator. When an invited user activates/selects the invitation (e.g., XR link, uniform resource locator (URL)), a travel controller or matchmaking service can fetch the intent object (e.g., based on the URL) and determine the target location for traveling the user (e.g., suitable environment instance/location) accordingly. This decoupling defers resource binding to a later stage, provides more flexibility, less resource constraints, and less risk for running into race conditions or resource haul.

Some implementations also decouple intent rules and world rules. When an invited user joins a virtual environment via an XR link, the corresponding intent object can verity that the invited user satisfies the invitation permissions. In some implementations, after the join request has been successfully verified, the intent object can initiate a matchmaking by calling a matchmaking service that exposes a set of primitive matchmaking operations. The matchmaking service can then verify these operations against world rules before they are finally executed. By decoupling the responsibilities of intent rules and world rules, the matchmaking service offloads some responsibility so that the service is freed from accounting for every possible scenario. In other words, implementations add flexibility to the matchmaking service by implementing intent objects that can be used to extend supported use cases.

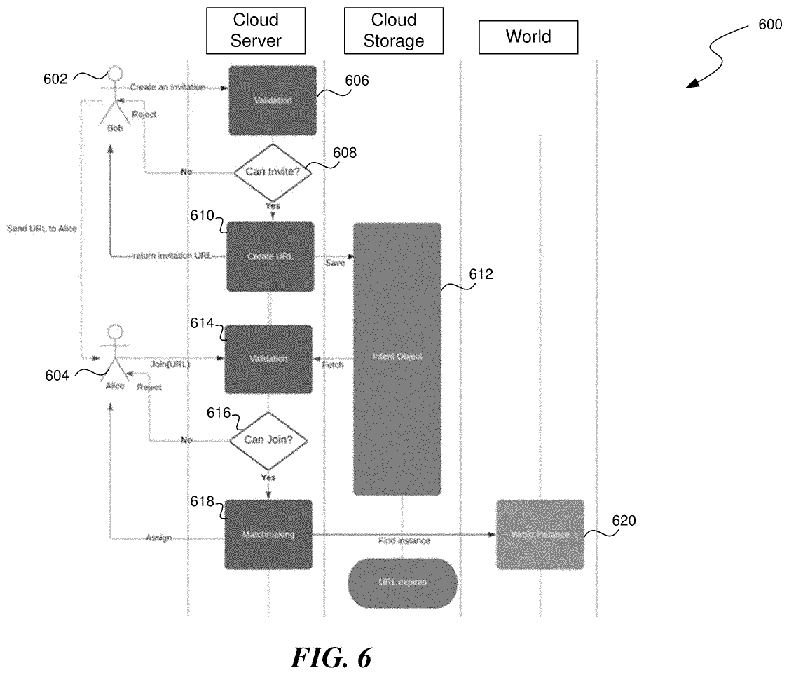

FIG. 6 is a sequence diagram illustrating a process 600 used in some implementations for inviting a target a user to a shared artificial reality environment using an intent configured artificial reality link. In some implementations, process 600 can generate a sharable XR invitation for a user and travel an invitee to the user's location (or to another suitable location) within an XR virtual environment. In the illustrated example, user 602 can create the XR invitation (e.g., XR web link) and share the XR invitation with user 604.

Blocks 606, 608, and 610 can represent a creation flow for the XR invitation created by user 602. For example, user 602 can specify a travel type for the XR invitation (e.g., travel to current location of a target user, travel to current location of a target group, travel to a defined XR environment location, travel to a current location of a target XR environment entity, such as a moving vehicle, etc.), a target entity (e.g., user 602 or another user, user group, vehicle, other XR entity, etc.), permitted users (e.g., permitted user identifiers, permitted groups of users, etc.), other suitable link permissions (e.g., maximum number of user link activations, remaining number of user link activations, other suitable permission definitions, etc.), any other suitable XR invitation information, or any combination thereof.

At block 606, the creation flow can validate the XR invitation specified by user 602. For example, user 602 may specific a location, user, user group, or other XR entity, and it can be validated that user 602 is permitted to specify such a target entity. In another example, the XR invitation may specify a private (or semi-private) XR environment location, it may be validated whether user 602 has permissions to invite other users to such a location. Other suitable validations can be performed at block 606.

At block 608, the creation flow can determine whether user 602 can create the specified XR invitation. When the XR invitation and user 602 are not validated, the XR invitation creation can be rejected. When the XR invitation and user 602 are validated, an XR link (e.g., URL) can be created for the XR invitation. In some implementations, intent object 612 that corresponds to the XR link can be generated and stored. For example, the intent object can store the travel type, target entity, permitted users, other suitable link permissions, or any combination thereof. In this example, the intent object can decouple the intent of the XR link (e.g., target user, travel type, other suitable permissions) from the XR link itself.

The created XR link can be shareable, and user 602 can share the created XR link with user 604. In some implementations, user 604 can select/activate the shared XR link (e.g., click/navigate to the URL) to travel to world instance 620 according to the intent data that corresponds to the XR link. Blocks 614, 616, and 618 can represent a travel flow for the XR invitation activated by user 604.

At block 614, the travel flow can validate that user 604 has permission and/or configurations to travel to world instance 620 using the activated XR link. For example, intent object 612 that corresponds to the XR link can be retrieved, and information for user 604 (e.g., user identifier, social graph, user computing device parameters, etc.) and/or input from user 604 can be compared to the definitions/permissions stored by intent object 612. At block 616, the travel flow can determine whether user 604 is validated to activate the XR link.

When user 604 is not validated to activate the XR link, the activation can be rejected. When user 604 is validated to activate the XR link, the travel flow can progress to block 618. At block 618, the travel flow can perform matchmaking to match user 604 to the intent object definitions/user input. For example, a current location for a target entity defined in intent object 612 can be determined. The current location can include an instance of virtual world 620 in which the target entity is present and the target entity's specific location within the instance. In some implementations, user 604 can be transported to the location within the instance of virtual world 620 discovered by performance of the matchmaking.

In some implementations, an XR invitation/link and/or intent object 612 can expire. For example, an expiration time, number of link activations, or other suitable expiration criteria can be defined. When the expiration criteria are met, the XR invitation link and/or intent object 612 can expire and users will no longer be validated to activate the XR link (e.g., at block 614 and block 616).

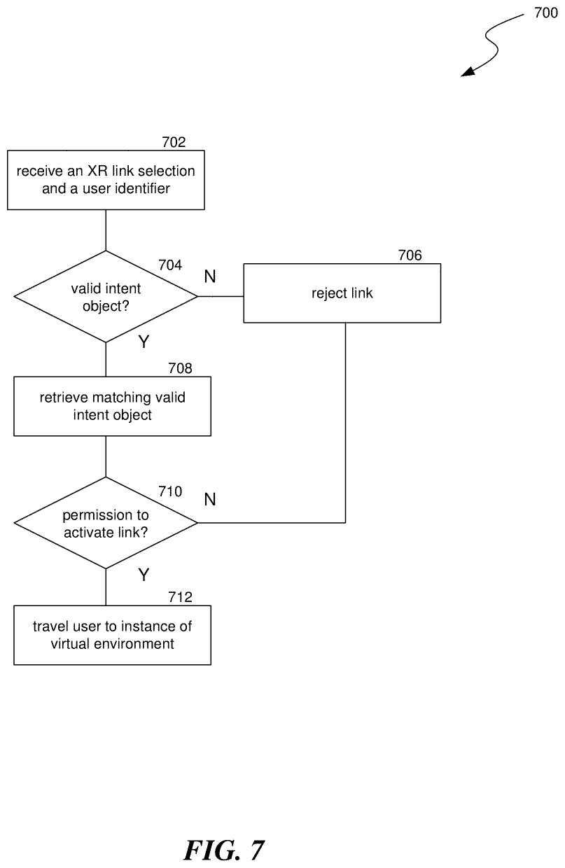

FIG. 7 is a flow diagram illustrating a process 700 used in some implementations for traveling a user to an artificial reality environment using an intent configured artificial reality link. In some implementations, process 700 can be performed in response to user activation of an XR link (e.g., web link selection). In some implementations, process 700 can be used to travel a user to a location and/or portion of an XR environment.

At block 702, process 700 can receive an XR link selection and a user identifier. In some implementations, the selected XR link can include a link identifier (e.g., web URL). The user identifier (e.g., social media identifier, XR environment subscription identifier, etc.) can correspond to a user that selected the XR link (e.g., clicked the web URL).

At block 704, process 700 can determine whether a valid intent object matches the XR link. For example, during creation of the XR link, an intent object can be generated which stores intent information that configures the XR link. An intent object can be stored in association with a link identifier for the XR link that corresponds to the intent object. In some implementations, a valid intent object can be found when the link identifier for the XR link matches a stored (e.g., unexpired) intent object.

When a valid intent object matches the XR link, process 700 can progress to block 708. When a valid intent object does not match the XR link, process 700 can progress to block 706. At block 706, process 700 can reject the XR link selection. For example, an error message that includes a description of an error (e.g., the XR link is invalid or expired) can be displayed.

At block 708, process 700 can retrieve one or more intent objects according to the XR link identifier. For example, the intent object that matches the link identifier for the XR link can be retrieved. In some implementations, the intent object identifies one or more target entities located within the XR environment. For example, during creation of the XR link/intent object, the creator (e.g., creating user) can define one or more target entities for the XR link/intent object. Example target entities include target users, target user groups, target locations, target vehicles, or other suitable target XR environment entities.

In some implementations, during creation of the XR link/intent object, the creator can also define a travel type for the XR link/intent object. Example travel types include travel to a current location of a defined user, travel to a current location of a defined group, travel to a defined XR environment location, travel to a current location of a defined XR environment entity, such as a moving vehicle, and any other suitable travel type for an XR link/intent object. The intent object can store the defined travel type.

In some implementations, during creation of the XR link/intent object, the creator can also define permissions for the XR link/intent object. Example permissions include permitted user identifiers, permitted groups of users, a maximum number of user link activations, a remaining number of user link activations, and any other suitable permission for an XR link/intent object. The intent object can store the defined permissions.

At block 710, process 700 can determine whether the user identifier is permitted to active the XR link. For example, the user identifier can be compared to intent object permissions to determine whether the user identifier is permitted to activate the link. Other suitable intent object permissions can also be validated, such as whether a maximum number of link activations has been met, whether open link invitations are available, or any other suitable permissions.

When the user identifier is permitted to active the XR link, process 700 can progress to block 712. When the user identifier is not permitted to active the XR link, process 700 can progress to block 706, where the link activation can be rejected. For example, an error message that includes a description of an error (e.g., user is not permitted to active the XR link, the XR link has no available open activations, etc.) can be displayed.

At block 712, process 700 can dynamically travel the user to a target location within an instance of the XR environment. In some implementations, the target location and the instance of the XR environment match at least one of the one or more target entities from the retrieved intent object(s). For example, the user can be dynamically traveled according to the travel type defined by the intent object. The user can be dynamically traveled to a current location of a target user within an instance of an XR environment, a current location of a moving vehicle within an instance of an XR environment, a current/predetermined location for a user group within an instance of an XR environment, and other suitable target locations.

As artificial reality (XR) devices become more prevalent, so do the applications available to be executed by such devices. However, such applications can be limited to the resources available on the XR device. It is desirable to keep the size of XR devices small, light, and cool in temperature, particularly when worn by a user, such as is the case with head-mounted displays (HMDs), also referred to herein as headsets. Because headsets require high processing power to continuously render video and audio, as well as to recognize and process user gestures and interactions, latency can be affected. Such latency problems are undesirable when processing needs to be performed in real-time or near real-time to improve the user experience.

Thus, some implementations of the present technology offload audio processing from an XR device to another device having higher processing speeds or lower load than the XR device. It is desirable that the other device have sufficient processing speeds to be able to process audio signals in real-time. Such high audio processing speeds can be desirable for XR applications that make heavy use of the microphone and speakers, such as in applications that employ singing.

For example, in an XR karaoke environment, audio processing can be too much load on the XR device, particularly if done concurrently with video rendering. Thus, some implementations offload the audio processing to a mobile device, such as a cellular phone, through coordination between the cellular phone and the XR device. Some cellular phones can process audio signals in real-time. Although described herein as “real-time”, it is contemplated that the processing speeds can be considered near real-time, as long as it does not result in a delay noticeable to a human.

In the XR karaoke environment, a user can select a song, effects, and other features on the XR device, which in turn can send audio controls to the user's cellular phone, and can act as a stage device. The phone can receive user audio (e.g., singing) through its microphone, process the audio according to the received controls, and can output the audio through earphones or headphones. Alternatively, the phone can send the processed audio back to the XR device. The XR device can perform various effects and provide virtual objects, such as by setting the background viewed by the user to match the selected song and showing the song lyrics and related virtual objects. One example of an XR device suitable for an XR karaoke experience is a headset.

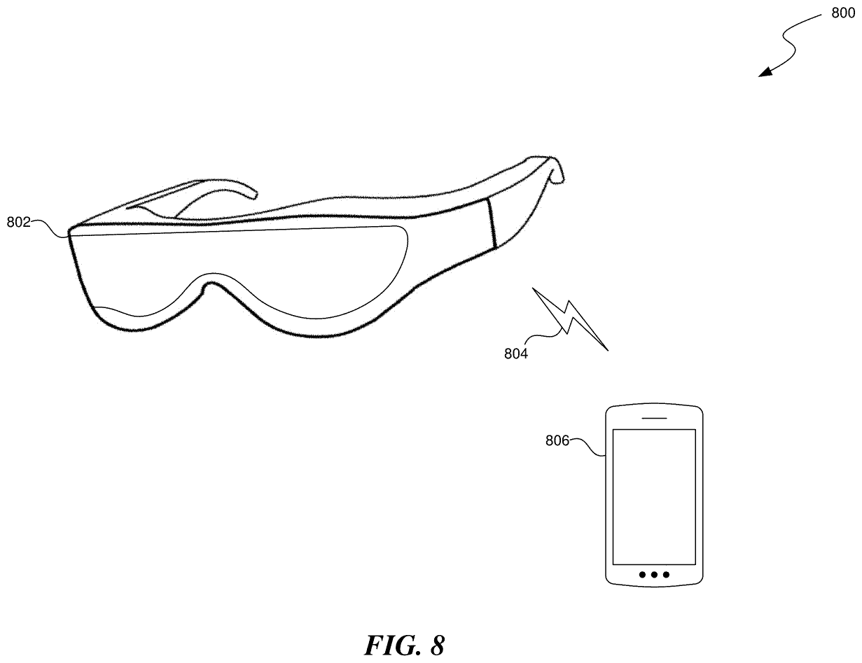

FIG. 8 is a conceptual diagram illustrating a system 800 of devices on which some implementations of the present technology can operate. System 800 can include an XR device, in this example a headset 802. System 800 can further include an external device capable of real-time audio processing, in this example mobile device 806. Mobile device 806 can be, for example, a cellular phone. However, it is contemplated that mobile device 806 can be any device external to headset 802 capable of performing audio processing in real-time. Headset 802 and mobile device 806 can be in operative communication with each other over network 804.

A user can select a song, effects, and other features on headset 802. Headset 802 can generate a command to mobile device 806 to activate its microphone. Headset 802 can generate further commands corresponding to changes that should be made to the audio signal received from the microphone, such as volume changes and effects changes. Mobile device 806 can receive the audio signal (e.g., corresponding to the user singing) through the microphone and alter the audio signal according to the received commands. Mobile device 806 can output the altered audio signal to earphones or headphones over network 804. In conjunction with the selected song, headset 802 can set the background viewed by the user to match the selected song and show the song lyrics and virtual objects on headset 802.

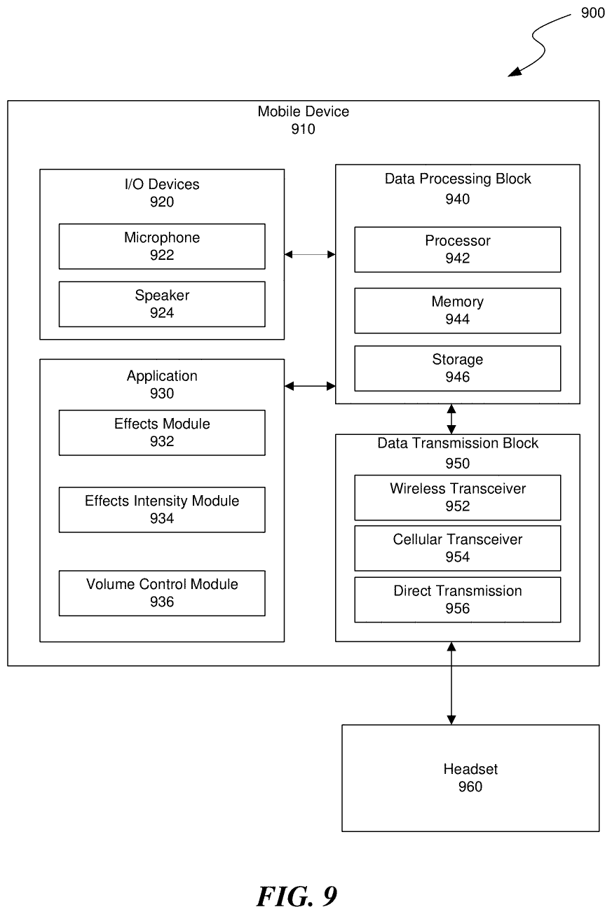

FIG. 9 is a block diagram illustrating an exemplary system 900 including a mobile device 910 on which some implementations of the present technology can operate. System 900 includes mobile device 910 and headset 960. Mobile device 910 includes a number of components, and in some implementations can be a cellular phone. For example, mobile device 910 can include input/output (I/O) devices 920, application 930, data processing block 940, and data transmission block 950.

I/O devices 920 can include microphone 922 and speaker 924. Microphone 922 can activate based on a command received from headset 960 and can capture audio signals from its environment. Speaker 924 can audibly output audio signals. I/O devices 920 can also include wired earphones or headphones (not shown) connected to mobile device 910.

Data processing block 940 includes processor 942, memory 944, and storage 946. Processor 942 can process and execute commands received from headset 960 in conjunction with I/O devices 920 and application 930. Storage 946 can store audio signals and effects as needed to perform the functions of application 930. Data processing block 940 is communicatively coupled to I/O devices and application 930 to perform the operations of application 930.

Data processing block 940 is communicatively coupled to data transmission block 950. Data transmission block 950 includes a number of components capable of communicating externally to other devices, such as with headset. For example, data transmission block 950 can include wireless transceiver 952, cellular transceiver 954, and direct transmission 956. Data transmission block 950 can receive commands from headset 960 and, in some implementations, can transmit an altered audio signal to headset 960.

Application 930 can perform audio processing in conjunction with processor 942, and can include an effects module 932, an effects intensity module 934, and a volume control module 936. Effects module 932 can apply effects to an audio signal received from microphone 922 in conjunction with processor 942 based on commands received from headset 960. Effects module 932 can apply any effects that alter an audio signal. For example, effects module 932 can apply a delay effect, a reverb effect, a chorus effect, a flanger effect, etc. Effects intensity module 934 can adjust the intensity with which an effect is applied by effects module 932 in conjunction with processor 942 based on commands received from headset 960. Volume control module 936 can adjust the amplitude of the audio signal (i.e., the volume of the audio signal) in conjunction with processor 942 based on commands received from headset 960.

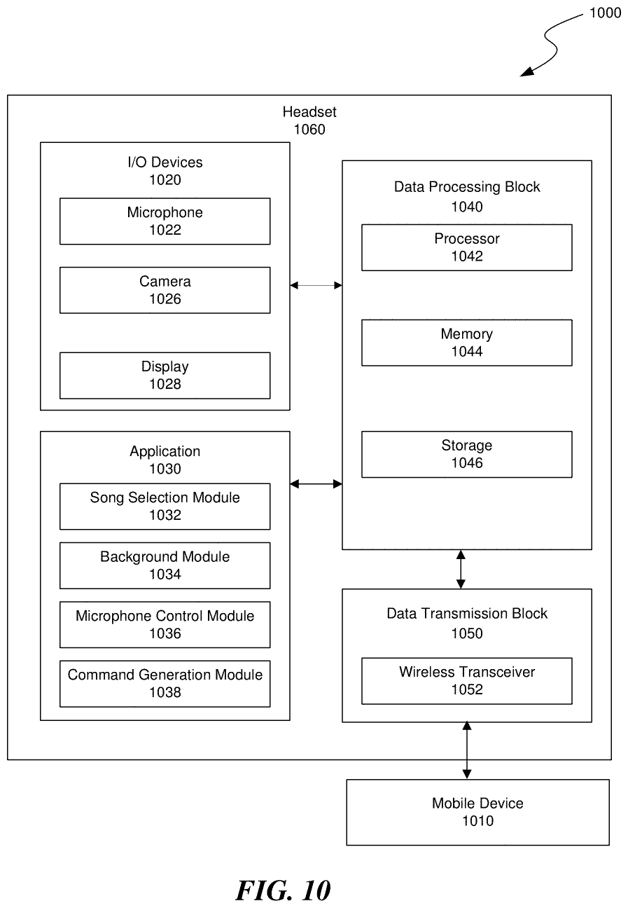

FIG. 10 is a block diagram illustrating an exemplary system 1000 including a headset 1060 according to some implementations of the present technology. System 1000 includes headset 1060 and mobile device 1010. Headset 1060 includes a number of components, and is one example of an XR device that can be used to perform the functions described herein. Headset 1060 can include input/output (I/O) devices 1020, application 1030, data processing block 1040, and data transmission block 1050.

I/O devices 920 can include microphone 1022, camera 1026, and display 1028. Microphone 1022 can be used to capture audio signals. Camera 1026 can be used to capture real-world objects, such as a user's hand and background environment, that can be displayed on display 1028. Display 1028 can display an XR environment with virtual objects, such as a virtual microphone, overlaid on the real world as captured by camera 1026.

Data processing block 1040 includes processor 1042, memory 1044, and storage 1046. Processor 1042 can operate to execute the functions of application 1030 in conjunction with I/O devices 1020. Storage 1046 can store any data needed to perform the functions of application 1030. Data processing block 1040 is communicatively coupled to I/O devices 1020 and application 1030 to perform the operations of application 1030.

Data processing block 1040 is communicatively coupled to data transmission block 1050. Data transmission block 1050 can include any components capable of communicating externally, such as with mobile device 1010. For example, data transmission block 1050 can include wireless transceiver 1052. In some implementations, data transmission block 1050 can receive an altered audio signal from mobile device 910. Data transmission block 1050 can transmit commands to mobile device 1010 using any known technology or protocol, such as MQTT, Bluetooth Low Energy (BLE), User Datagram Protocol (UDP), etc.

Application 1030 can be, for example, an XR karaoke application, and can perform all of the functions needed to give a user an XR karaoke experience other than the audio processing, the latter of which is performed by mobile device 1010. Application 1030 includes a song selection module 1032, a background module 1034, a microphone control module 1036, and a command generation module 1038. Song selection module 1032 can facilitate selection by a user of a song for which the user would like a karaoke experience, in conjunction with display 1028 and processor 1042. Background module 1034 can select an appropriate background to be displayed on display 1028 to the user based on the selected song in conjunction with processor 1042. In some implementations, background module 1034 can facilitate selection by a user of an appropriate background in conjunction with display 1028 and processor 1042.

Microphone control module 1036 can, in conjunction with processor 1042 and display 1028, display a virtual microphone having a variety of controls. Microphone control module 1036 can further, in conjunction with processor 1042 and camera 1026, track a user's movements, such as a user's hand and finger movements or the movement of a controller, with respect to the virtual microphone and determine that a user is holding the virtual microphone, moving the virtual microphone, selecting a particular button on the virtual microphone, etc. When it is determined that the user is selecting a particular button on the virtual microphone, microphone control module 1036 can transmit a message including information regarding which button was selected and any other data relevant to the button to transmit to command generation module 1038.

Command generation module 1038, in conjunction with processor 1042, receives messages from microphone control module 1036 that indicate that a particular button on the virtual microphone has been selected. Command generation module 1038 converts the message into a command having a format transmittable to mobile device 210 via wireless transceiver 1052. For example, command generation module 1038, in conjunction with processor 1042, can generate a command indicating that mobile device 1010 should apply a particular effect to an audio signal, increase or decrease the intensity of an effect applied to the audio signal, increase or decrease the volume of an audio signal, active or deactivate a microphone on mobile device 1010, etc.

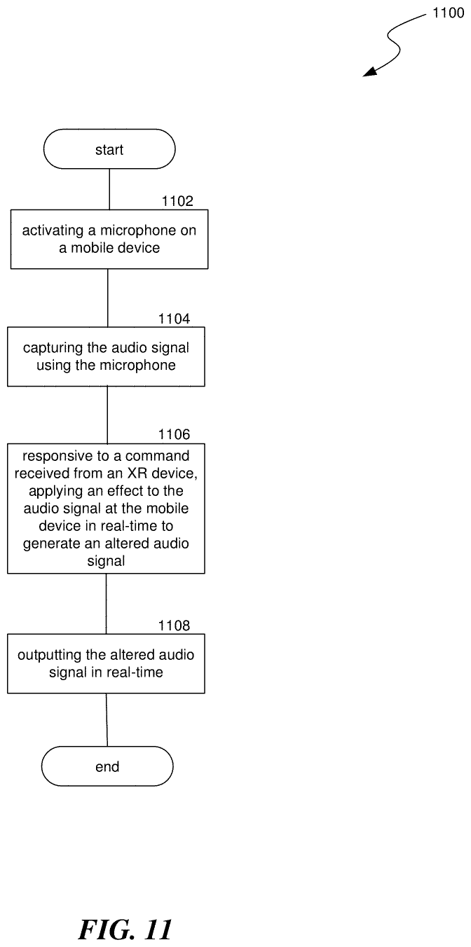

FIG. 11 is a flow diagram illustrating a process 1100 for performing off-headset audio processing according to some implementations of the present technology. In some cases, process 1100 can be performed as part of an application executed on a mobile device, e.g., by a user or in response to a remote command from an XR device. In some implementations, process 1100 can be performed “just in time,” e.g., as a response to a user making a selection on a virtual microphone.

At block 1102, process 1100 can activate a microphone on a mobile device. In some implementations, process 1100 can activate the microphone based on a command received from a XR device. The XR device can generate the command based on a user's selection of a virtual button corresponding to turning a virtual microphone on.

At block 1104, process 1100 can capture the audio signal using the microphone. In some implementations, the audio signal can correspond to a user speaking or singing, such as in an XR karaoke experience.

At block 1106, responsive to a command received from the XR device, process 1100 can apply an effect to the audio signal at the mobile device in real-time to generate an altered audio signal. The effects can include, for example, a delay effect, a reverb effect, a chorus effect, a flanger effect, etc. The XR device can generate the command based on a user's selection of a virtual button corresponding to a desired effect. In some implementations, other commands can be received from the XR device, such as to increase or decrease the intensity of an effect applied to the audio signal, increase or decrease the volume of an audio signal, etc.

At block 1108, process 1100 can output the altered audio signal to earphones or headphones in real-time, which can be wired. In some implementations, the mobile device can transmit the altered audio signal to the XR device.

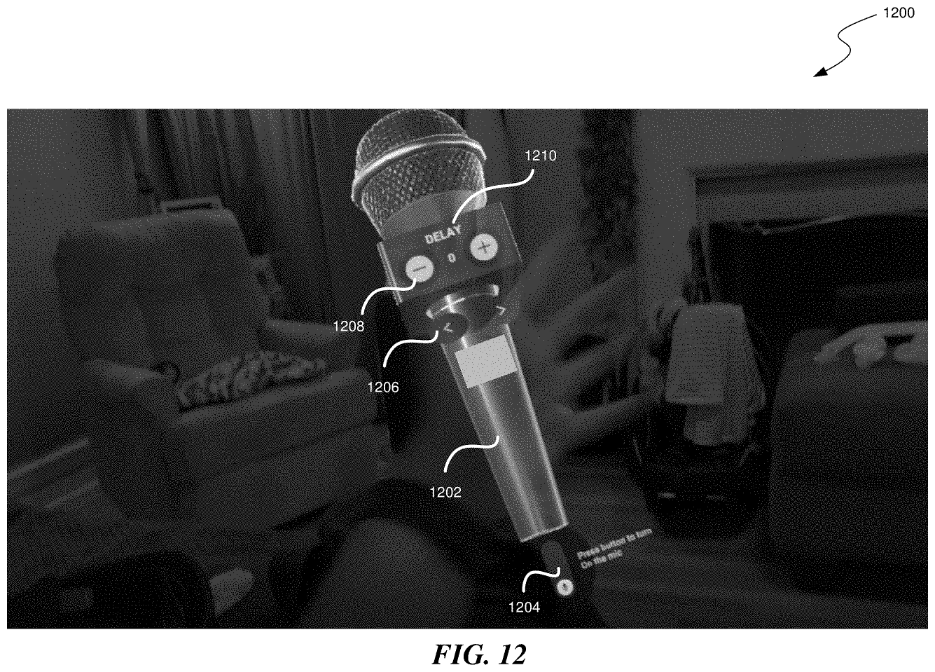

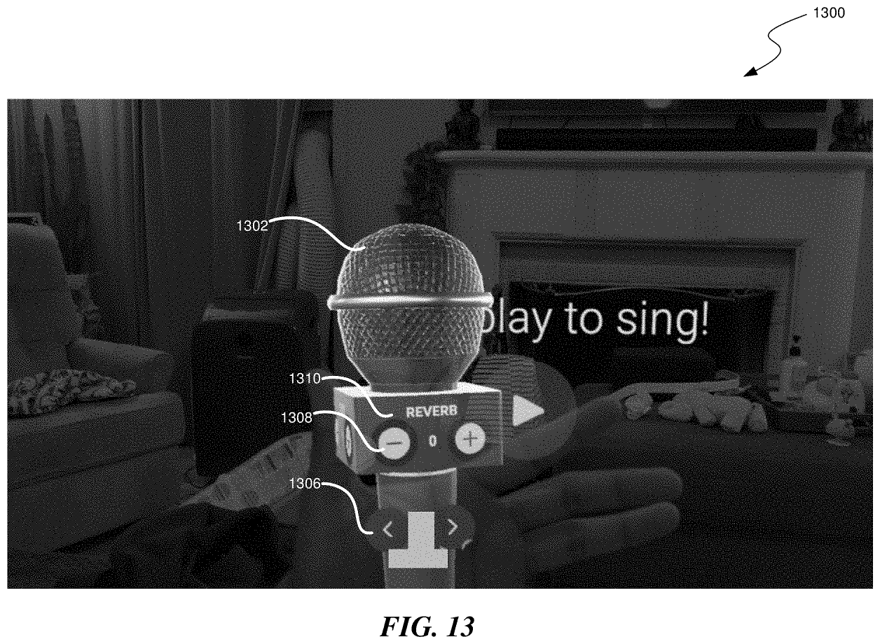

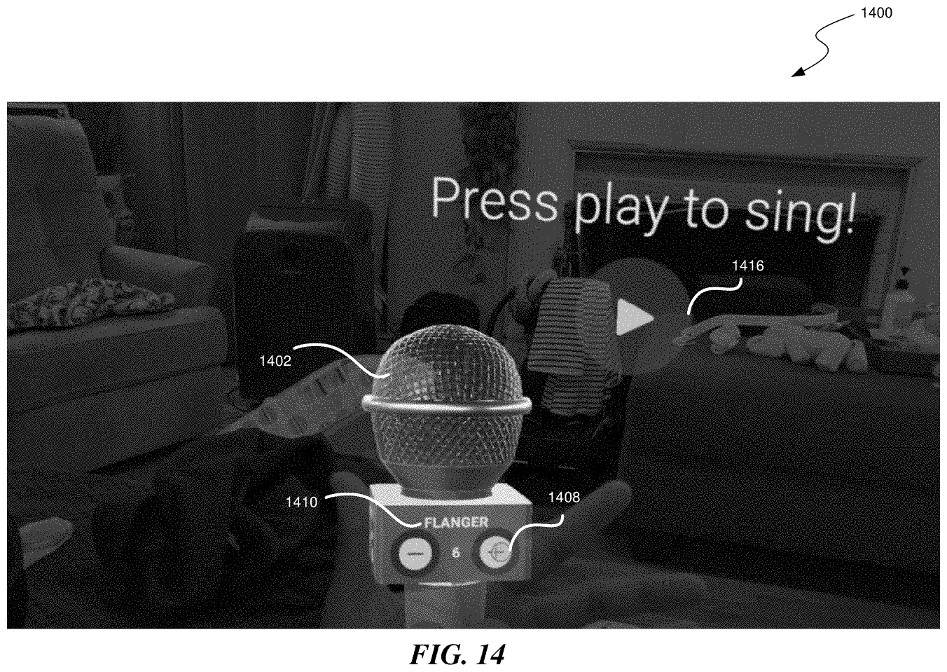

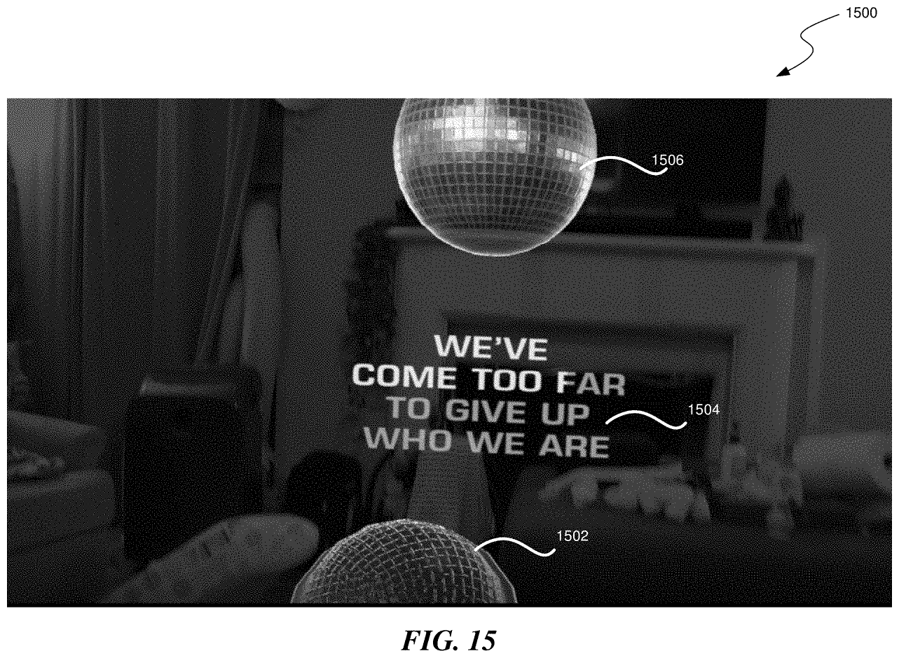

FIGS. 12-15 are screenshots 1200, 1300, 1400, 1500, respectively, of views of an exemplary XR application that can be used in conjunction with some implementations of the present technology. Screenshot 1200 shows a virtual microphone 1202 as displayed on a display of an XR device, such as a headset. In some implementations, virtual microphone 1202 can “lock” to a user's hand, such that the microphone moves relative to user's hand.

Virtual microphone 1202 includes a number of virtual objects and buttons. For example, virtual microphone 1202 can include toggle switch 1204 corresponding to turning virtual microphone 1202 on and off. Selection of toggle switch 1204 can generate a command on the headset transmitted to a mobile device to turn a real-world microphone on the mobile device on or off.

Virtual microphone 1202 can include effect selection buttons 1206. Selection of effect selection buttons 1206 can change effect 1210 displayed on the virtual microphone. In screenshot 1200, effect 1210 is a delay effect.

Virtual microphone 1202 can further include effect intensity buttons 1208. Selection of effect intensity buttons 1208 can change the intensity of the effect being applied to an audio signal, in this case delay effect 1210. The “+” button can increase the intensity of delay effect 1210, and the “−” button can decrease the intensity of delay effect 1210. Selection of effect intensity buttons 1208 can generate a command on the headset transmitted to a mobile device to apply an effect of a certain intensity to an audio signal captured by the real-world microphone on the mobile device if toggle switch 1204 is in an “on” position. Although illustrated as particular switches and buttons herein, it is contemplated that any suitable switch, button, or object can be used to make selections relevant to virtual microphone 1202.

Screenshot 1300 shows a view of virtual microphone 1302 after effect selection button 1306 has been selected, causing the display of the effect to change from a delay effect to a reverb effect 1310. Reverb effect 1310 is associated with a set of effect intensity buttons 1208 that can be selected to increase or decrease the intensity of a reverb effect applied by the mobile device to an audio signal.

Screenshot 1400 shows a view of virtual microphone 1402 after an effect selection button has been selected, and causes the display of the effect to change from a reverb effect to a flanger effect 1410. In screenshot 1400, a user has selected to increase flanger effect 1410 to a level of “6” via effect intensity button 1408. Selection of effect intensity button 1408 can generate a command on the headset transmitted to a mobile device to apply flanger effect 1410 of intensity level “6” to an audio signal captured by the real-world microphone on the mobile device.

Screenshot 1500 shows a view of a karaoke environment while the user is singing a selected song. Screenshot 1500 shows virtual objects overlaid on real-world images captured by a camera. The virtual objects can include microphone 1502, lyrics 1504 that can highlight the current words to be sung, and disco ball 1506. In some implementations, the selection, processing, and display of microphone 1502, lyrics 1504, and disco ball 1506 can be implemented on a headset separate from the mobile device capturing the audio signal. In some implementations, the instrumental song can be output on the headset, while the altered audio signal can be output on the mobile device in real-time. In some implementations, both the instrumental song and the altered audio signal can be output on the headset after processing by the mobile device.

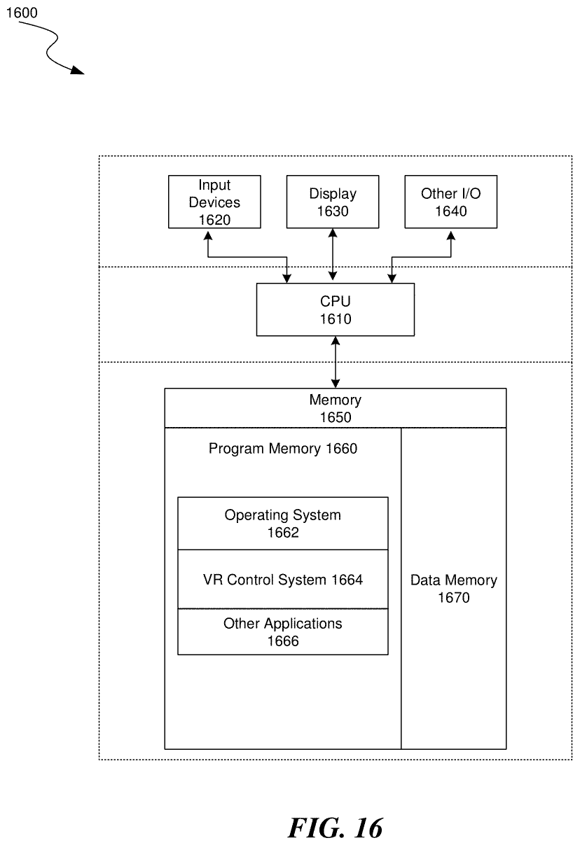

FIG. 16 is a block diagram illustrating an overview of devices on which some implementations of the disclosed technology can operate. The devices can comprise hardware components of a device 1600. Device 1600 can include one or more input devices 1620 that provide input to the Processor(s) 1610 (e.g., CPU(s), GPU(s), HPU(s), etc.), notifying it of actions. The actions can be mediated by a hardware controller that interprets the signals received from the input device and communicates the information to the processors 1610 using a communication protocol. Input devices 1620 include, for example, a mouse, a keyboard, a touchscreen, an infrared sensor, a touchpad, a wearable input device, a camera- or image-based input device, a microphone, or other user input devices.

Processors 1610 can be a single processing unit or multiple processing units in a device or distributed across multiple devices. Processors 1610 can be coupled to other hardware devices, for example, with the use of a bus, such as a PCI bus or SCSI bus. The processors 1610 can communicate with a hardware controller for devices, such as for a display 1630. Display 1630 can be used to display text and graphics. In some implementations, display 1630 provides graphical and textual visual feedback to a user. In some implementations, display 1630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1640 can also be coupled to the processor, such as a network card, video card, audio card, USB, firewire or other external device, camera, printer, speakers, CD-ROM drive, DVD drive, disk drive, or Blu-Ray device.

In some implementations, the device 1600 also includes a communication device capable of communicating wirelessly or wire-based with a network node. The communication device can communicate with another device or a server through a network using, for example, TCP/IP protocols. Device 1600 can utilize the communication device to distribute operations across multiple network devices.

The processors 1610 can have access to a memory 1650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1650 can include program memory 1660 that stores programs and software, such as an operating system 1662, VR Control System 1664, and other application programs 1666. Memory 1650 can also include data memory 1670 which can be provided to the program memory 1660 or any element of the device 1600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

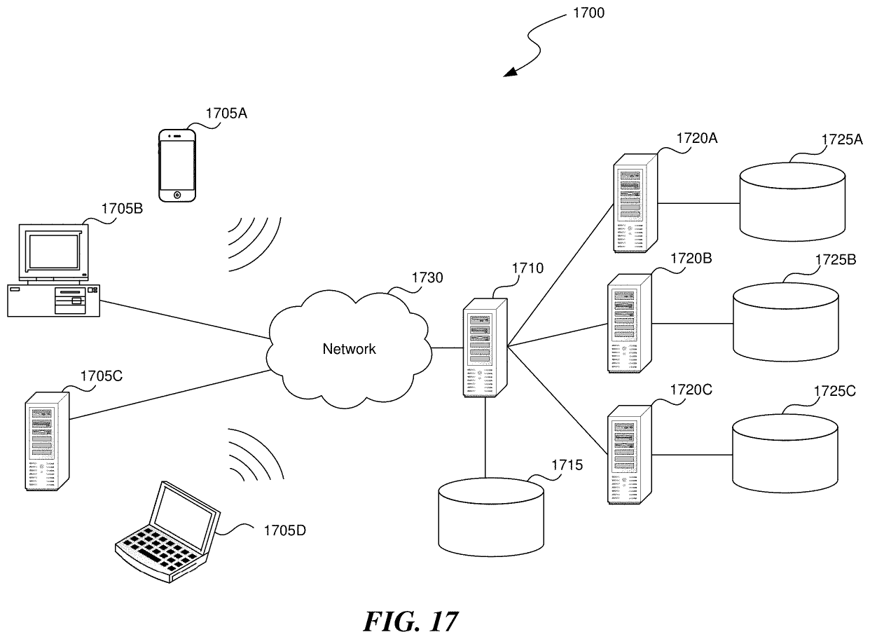

FIG. 17 is a block diagram illustrating an overview of an environment 1700 in which some implementations of the disclosed technology can operate. Environment 1700 can include one or more client computing devices 1705A-D, examples of which can include device 1600. Client computing devices 1705 can operate in a networked environment using logical connections through network 1730 to one or more remote computers, such as a server computing device.

In some implementations, server 1710 can be an edge server which receives client requests and coordinates fulfillment of those requests through other servers, such as servers 1720A-C. Server computing devices 1710 and 1720 can comprise computing systems, such as device 1600. Though each server computing device 1710 and 1720 is displayed logically as a single server, server computing devices can each be a distributed computing environment encompassing multiple computing devices located at the same or at geographically disparate physical locations. In some implementations, each server 1720 corresponds to a group of servers.

Client computing devices 1705 and server computing devices 1710 and 1720 can each act as a server or client to other server/client devices. Server 1710 can connect to a database 1715. Servers 1720A-C can each connect to a corresponding database 1725A-C. As discussed above, each server 1720 can correspond to a group of servers, and each of these servers can share a database or can have their own database. Databases 1715 and 1725 can warehouse (e.g., store) information. Though databases 1715 and 1725 are displayed logically as single units, databases 1715 and 1725 can each be a distributed computing environment encompassing multiple computing devices, can be located within their corresponding server, or can be located at the same or at geographically disparate physical locations.

Network 1730 can be a local area network (LAN) or a wide area network (WAN), but can also be other wired or wireless networks. Network 1730 may be the Internet or some other public or private network. Client computing devices 1705 can be connected to network 1730 through a network interface, such as by wired or wireless communication. While the connections between server 1710 and servers 1720 are shown as separate connections, these connections can be any kind of local, wide area, wired, or wireless network, including network 1730 or a separate public or private network.

In some implementations, servers 1710 and 1720 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user, And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph, Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing pseudo-live images of a real-world space, the method comprising:
generating a 3D model based on depth data from scans of a real-world space;
placing a virtual camera in the 3D model;
recording one or more pseudo-live images from the virtual camera; and
creating a live-feed, for the real-world space, based on the one or more pseudo-live images.

2. A method for traveling a user to an artificial reality (XR) environment using an intent configured XR link, the method comprising:
receiving an XR link selection and a user identifier, wherein the selected XR link comprises a link identifier;
retrieving an intent object according to the XR link identifier, wherein the intent object defines one or more target entities located within an XR environment;
comparing the user identifier to intent object permissions to determine that the user identifier is permitted to activate the XR link; and
dynamically traveling the user to a target location within an instance of the XR environment, wherein the target location and the instance of the XR environment match at least one of the one or more target entities.

3. A method for processing an audio signal off-headset for an XR experience, the method comprising:
activating a microphone on a mobile device;
capturing the audio signal using the microphone;
responsive to a command received from an XR device, applying an effect to the audio signal at the mobile device in real-time to generate an altered audio signal; and
outputting the altered audio signal to headphones or the XR device in real-time.
